(19) United States
(12) Patent Application Publication
(10) Pub. No.: US 2012/0030355 A1
(43) Pub. Date: Feb. 2, 2012

(54) DYNAMICALLY ALLOCATING INDEX SERVER RESOURCES TO PARTNER ENTITIES

(75) Inventors: Sridharan Iyer, Woodinville, WA (US); Xun Kang, Kirkland, WA (US); Pin Lu, Bellevue, WA (US); Junhua Wang, Sammamish, WA (US); Jian Cao, Redmond, WA (US)

(73) Assignee: Microsoft Corporation, Redmond, WA (US)

(21) Appl. No.: 12/844,823

(22) Filed: Jul. 27, 2010

(51) Int. Cl. G06F 15/173

(52) U.S. Cl. 709/226

(57) ABSTRACT

A provisioning system is described for dynamically and automatically allocating index server resources to different respective uses. For example, the provisioning system can allocate index server resources among different search-related production uses, different analysis-related uses, different testing-related uses, and so on. In one case, the provisioning system includes an allocation manager module that receives information that has a bearing on the allocation of index server resources. Based on this information, the allocation manager module determines an allocation of index server resources and sends instructions to an indexing system to carry out the allocation. In one case, the indexing system respond to the instructions by allocating rows of index server resources to different partner entities which have requested index server resources. Each row can also implement custom index information and/or custom processing functionality for use by particular partner entities.

### BACKGROUND

A search engine system may employ a large collection of index servers to process a query submitted by a user. In operation, the search engine system uses load balancing functionality to route the user's query to a subset of the index servers, each of which implements a portion of global index information. The search engine system can aggregate the results provided by the individual index servers to generate a final set of relevant documents. The search engine system then conveys its results to the user in the form of a list of text snippets and URLs associated with the set of top documents.

To provide satisfactory user experience, an administrator of a search engine system will attempt to deploy a sufficient number of index servers to meet anticipated user demand. However, there are several factors which complicate this task. For instance, the demand for search-related services may fluctuate over the course of a day. Further, the demand for search-related services may experience spikes upon the occurrence of unusual events, such as significant news events. Further still, the demand for search-related services is expected to increase over time as more users gain access to the Internet.

As one general strategy, the administrator may attempt to “over-provision” a search engine system so that it includes more index server resources than will typically be needed, even for peak periods of demand. In addition, the administrator may decide to progressively increase the number of index servers over the course of time in an attempt to keep pace with increasing demand. However, these strategies are not fully satisfactory. A search engine system that is over-provisioned may leave many index servers idle or underutilized at times, which is an inefficient use of these resources. Further, the administrator may have difficulty in matching the long-term increase in customer demand, from both technical and financial standpoints.

When an administrator does decide to make a change to a search engine system, he or she does so in a manual manner, e.g., by increasing or decreasing the number of index servers and/or changing the configuration of existing index servers, etc. The changes defined thereby are static; they remain in place until the administrator decides to make additional changes to the search engine system. Such manual modification is a cumbersome and error prone process. Furthermore, this manual modification may take a significant amount of time to perform. During this “down time,” the index server resources remain unavailable for use by end users.

### SUMMARY

A provisioning system is described for dynamically and automatically allocating index server resources to different respective uses associated with different respective partner entities. In one implementation, the provisioning system includes an allocation manager module which receives information that has a bearing on the allocation of index server resources. Based on this information, the allocation manager module determines an allocation of index server resources and sends instructions to an indexing system to carry out the allocation. In one case, the indexing system responds to the instructions by allocating rows of index server resources to different partner entities. The allocation manager module repeats this process on a periodic basis or otherwise, automatically making changes to the allocation of index server resources when deemed appropriate.

According to one illustrative aspect, at least one partner entity may request use of the index server resources to perform an evaluation-related task. For example, this type of partner entity can request index server resources to assess the relevance of search results provided by a search engine system. Alternatively, or in addition, at least one partner entity may request use of the index server resources to provide a search-related service in a defined geographic area (e.g., in a specified country). Alternatively, or in addition, at least one partner entity may request use of the index server resources to test processing functionality in a trial mode prior to deployment of the processing functionality by the search engine system, and so on. The provisioning system can accommodate yet other types of partner entities and associated uses of the search engine system.

According to another illustrative aspect, at least one partner entity may also request that the index server resources be used in conjunction with particular index information. For example, a partner entity which hosts a search-related service in a foreign country may request index server resources which implement index information that is associated with a particular corpus of foreign language documents. Alternatively, or in addition, at least one partner entity may request that the index server resources be used in conjunction with specified processing functionality (e.g., specified code). For example, a partner entity which seeks to test a new search algorithm, may request index server resources which implement code associated with the new search algorithm.

According to another illustrative aspect, the allocation manager module can collect different types of information. Such collected information influences its allocation decisions. For example, the allocation manager module can receive: (1) request information that describes the requests for index server resources made by partner entities; (2) traffic information that describes the current use of the index server resources (which can be expressed in terms of load and latency); and (3) management status information that describes the current status of the index server resources, and so on.

According to another illustrative aspect, the provisioning system includes a monitoring module that enables a user to review the current allocation of index server resources in the search engine system.

More generally stated, the provisioning system provides an efficient mechanism to satisfy vying requests for index server resources. Further, the provisioning system reduces the amount of idle or underutilized index server resources provided by a search engine system, while still meeting demands placed on the search engine system by mainline business needs. Further, the provisioning system accomplishes these goals in an automatic (or at least semi-automatic) manner, reducing the burden that would otherwise be imposed on an administrator. These potential benefits are cited by way of illustration, not limitation.

The above approach can be manifested in various types of systems, components, methods, computer readable media, data structures, articles of manufacture, and so on.

This Summary is provided to introduce a selection of concepts in a simplified form; these concepts are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 shows an illustrative provisioning system in which index server resources can be dynamically and automatically allocated to one or more partner entities.

FIG. 2 shows an index server system for use in conjunction with the provisioning system of FIG. 1.

FIG. 3 is a graph which depicts demand for search-related services for the case in which dynamic allocation is performed and for the case in which dynamic allocation is not performed.

FIGS. 4-6 show three different multi-site implementations of the provisioning system of FIG. 1.

FIG. 7 is shows a procedure that represents one manner of operation of the provisioning system of FIG. 1

FIG. 8 shows illustrative processing functionality that can be used to implement any aspect of the features shown in the foregoing drawings.

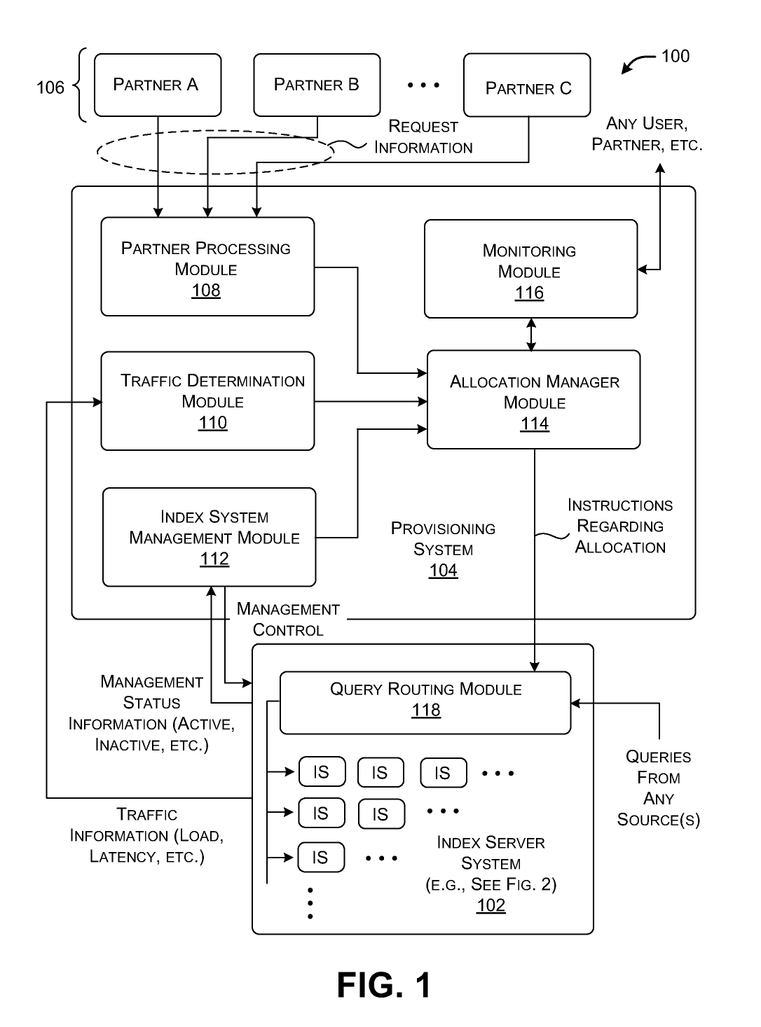

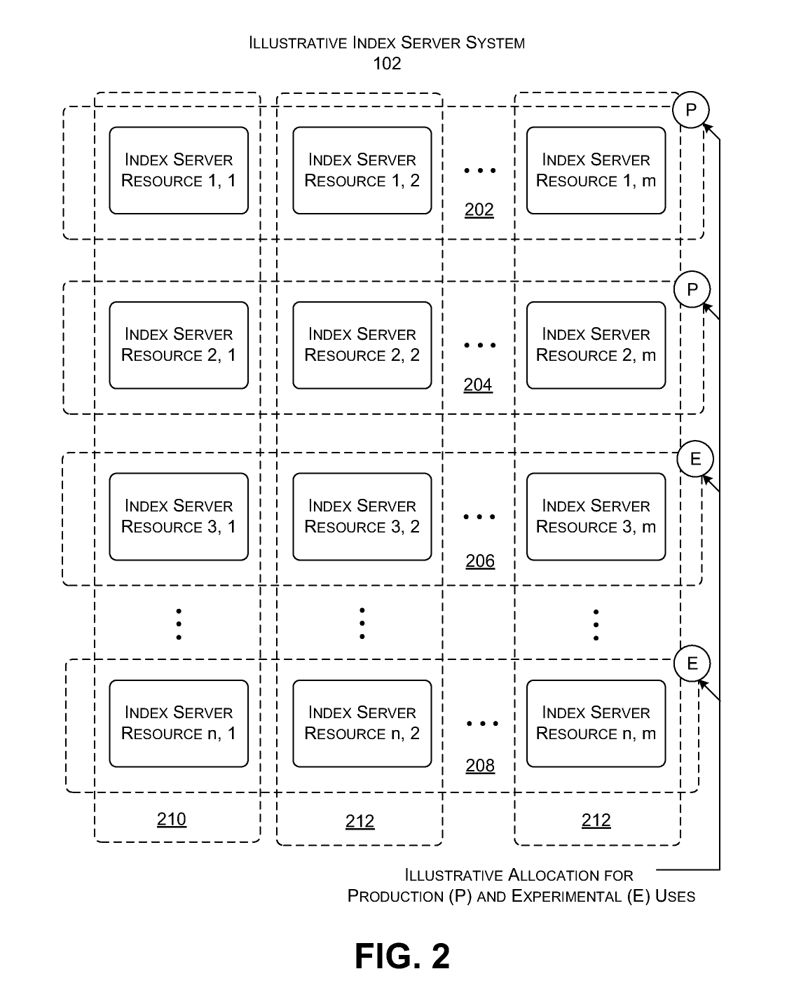

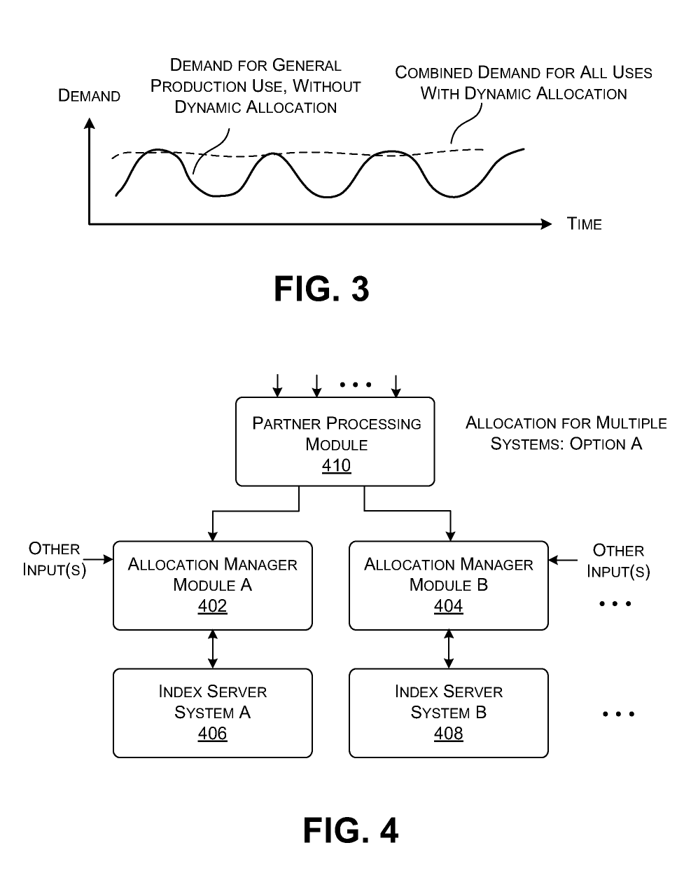

The same numbers are used throughout the disclosure and figures to reference like components and features. Series 100 numbers refer to features originally found in FIG. 1, series 200 numbers refer to features originally found in FIG. 2, series 300 numbers refer to features originally found in FIG. 3, and so on.

### DETAILED DESCRIPTION

This disclosure is organized as follows. Section A describes an illustrative provisioning system which allocates index server resources among different partner entities. Section B describes illustrative methods which explain the operation of the provisioning system of Section A. Section C describes illustrative processing functionality that can be used to implement any aspect of the features described in Sections A and B.

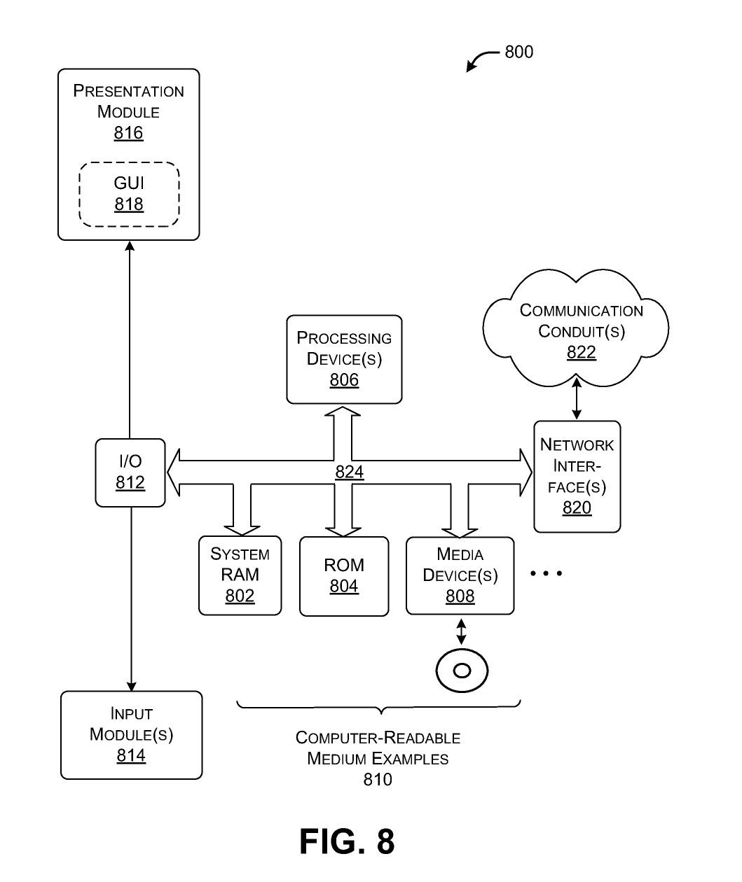

As a preliminary matter, some of the figures describe concepts in the context of one or more structural components, variously referred to as functionality, modules, features, elements, etc. The various components shown in the figures can be implemented in any manner. In one case, the illustrated separation of various components in the figures into distinct units may reflect the use of corresponding distinct components in an actual implementation. Alternatively, or in addition, any single component illustrated in the figures may be implemented by plural actual components. Alternatively, or in addition, the depiction of any two or more separate components in the figures may reflect different functions performed by a single actual component. FIG. 8, to be discussed in turn, provides additional details regarding one illustrative implementation of the functions shown in the figures.

Other figures describe the concepts in flowchart form. In this form, certain operations are described as constituting distinct blocks performed in a certain order. Such implementations are illustrative and non-limiting. Certain blocks described herein can be grouped together and performed in a single operation, certain blocks can be broken apart into plural component blocks, and certain blocks can be performed in an order that differs from that which is illustrated herein (including a parallel manner of performing the blocks). The blocks shown in the flowcharts can be implemented in any manner.

The following explanation may identify one or more features as “optional.” This type of statement is not to be interpreted as an exhaustive indication of features that may be considered optional; that is, other features can be considered as optional, although not expressly identified in the text. Similarly, the explanation may indicate that one or more features can be implemented in the plural (that is, by providing more than one of the features). This statement is not be interpreted as an exhaustive indication of features that can be duplicated. Finally, the terms “exemplary” or “illustrative” refer to one implementation among potentially many implementations.

A. Illustrative Systems

FIG. 1 shows a search engine system 100 that provides a search-related service to users. That is, a user submits a query to the search engine system 100, and, in response, receives search results from the search engine system 100. The search results identify documents selected from a corpus of documents which are relevant to the query. In one case, the corpus of documents corresponds to pages that can be accessed via the Internet.

The search engine system 100 provides an index server system 102 that performs the core function of identifying relevant documents. Accordingly, this section begins by providing an introductory explanation of the index server system 102. In one implementation, the index server system 102 includes a plurality of index servers, referred to as index server resources herein. For example, FIG. 2 shows one collection of index server resources that includes a plurality of rows (202, 204, 206, . . . 208) and columns (210, 212, . . . 214) of index server resources. Each index server resource stores a portion of index information corresponding to a subset of documents within an entire corpus of searchable documents. The index information associates the content of the documents with corresponding document identifiers. Using this information, an index server resource can identify a set of documents which are deemed relevant to terms provided in a query.

More specifically, each index server resource in a row stores a portion of index information. The aggregate of the portions provided in the row represents the entire corpus of searchable documents. For example, assume that a row includes 500 index server resources and that the entire corpus includes one million searchable documents. Each index server resource can therefore store an index portion that corresponds to a 2000-document segment of the corpus. Other rows in the index server system 102 provide redundant copies of the index information. Accordingly, any column of index server resources may provide an identical portion of index information. In the example cited above, the first column can store the same portion of index information that represents the same 2000 documents in the entire corpus.

In operation, the search engine system 100 can use load balancing functionality to direct a user's query to an appropriate row in the index server system 102 (in the manner to be described below). Each of the index server resources identifies a set of m documents that are deemed relevant to the query. The search engine system 100 aggregates the results provided by the index server resources in a row to provide a final list of p relevant documents, which it forwards to the user.

Traditionally, an administrator sets up a search engine system in a manual fashion. For example, an administrator may set up all of the index server resources in the index server system 102 to handle normal production traffic. The administrator may change the index server system 102, but, again, this is done in a manual fashion. For example, the administrator can add new index server resources to the index server system 102. Once set up, the capacity of a traditional index server system will exceed user demand at certain times. This means that, in the traditional case, a certain percentage of the index server system's resources may remain idle or underutilized at certain times.

Returning to FIG. 1, the search engine system 100 shown there, by contrast to traditional architectures, includes a provisioning system 104. The provisioning system 104 determines the resource needs of different partner entities 106 which request use of the index server system 102. The provisioning system 104 then dynamically and automatically allocates different portions of the index server resources to the partner entities 106 (if possible). For example, the provisioning system 104 can allocate different respective groups of rows shown in FIG. 2 to different partner entities 106. The allocation is dynamic in the sense that it is responsive to various environmental factors which change over time, to be described below. The allocation is automatic in the sense that it does not require manual intervention by a user. However, in other implementations, the allocation may be regarded as semi-automatic insofar as it involves at least some manual intervention by a user, such as by asking the user to manually verify the appropriateness of certain proposed changes.

The partner entities 106 correspond to different uses of the index server system 102. In some cases, a partner entity may be associated with one or more human agents. In addition, or alternatively, in some cases, a partner entity may be associated with functional components and/or infrastructure for performing a prescribed task.

For example, a first partner entity may correspond to an analyst who wishes to run relevancy experiments on the index server system 102. In performing this task, the analyst may submit a batch of experimental queries to the index server system 102. Upon receiving search results, the analyst can evaluate the relevancy of the search results.

A second partner entity may correspond to a developer who has designed a new search algorithm for deployment by the index server system 102. For example, the developer may have designed a new neural network that is used to identify relevant documents. The developer may wish to test the new search algorithm before formally deploying the search algorithm for general use in a main production environment.

A third partner entity may correspond to an affiliate which seeks to provide search-related services in a particular domain. For example, this partner entity may correspond to an affiliate which provides a search-related service in an identified geographic region, such as a particular country or region of the world. The affiliate may allow users to search a sub-corpus of documents that is particularly tailored to meet the needs of the geographic region.

A fourth partner entity may correspond to a business entity or other third party entity which seeks dedicated search-related services for exclusive use within its business or other organization. That type of third party may pay a fee to receive a certain amount of index server resources.

These partner entities are mentioned by way of example, not limitation. Still other partner entities may wish to utilize the resources of the index server system 102 for particular uses.

In the above-cited examples, the uses sought by the partner entities 106 can be considered supplemental to a main production use of the index server system 102. The main production use may employ the index server system 102 to provide search-related services to a general population of end users. In this case, the provisioning system 104 implicitly takes into account the resource requests being made by the main production use. However, in another case, the main production use can itself be considered a partner entity. In this case, the main production use specifies its demands for index server resources in the same manner as “supplemental” uses associated with other partner entities.

The provisioning system 104 allocates index server resources to the partner entities 106 by collecting and analyzing different types of information corresponding to different environment factors. For example, the provisioning system 104 includes a partner processing module 108 that receives request information from the partner entities 106. The request information describes the resource needs of the various partner entities.

For example, a partner entity may specify an amount of desired index serving resources. For example, a partner entity can quantify the amount by specifying the volume of queries it requests to be processed per second, referred to as Queries-Per-Second, or QPS. The partner entity can also identify the type of search-related services it desires. For example, a partner entity can specify that it wishes to use custom index information to perform its search-related services. For example, a partner which provides a search-related service in a foreign country may request index server resources that store customized foreign index information; that index information corresponds to a sub-corpus of foreign-language documents selected from a global corpus of general documents. Alternatively, or in addition, a partner can specify that it wishes to use particular processing functionality to perform its search-related services. For example, a partner which plans to test processing functionality before more widely deploying it can request index serving resources that run the new processing functionality. These examples are presented by way of illustration, not limitation; the request information can specify yet other characteristics of a partner entity's processing needs.

In one implementation, each partner entity can formulate the request information as a descriptive file of any type. The partner processing module 108 may act as a multiplexer which combines this request information from plural partner entities. Alternatively, or in addition, one or more partner entities may directly forward the request information to the provisioning system 104 without the intermediary of a multiplexing-type partner processing module 108.

The provisioning system 104 also may employ a traffic determination module 110. The traffic determination module 110 provides traffic information that describes the behavior of currently-allocated index server resources. These index server resources refer to resources that are currently being used to process queries. For example, the traffic determination module 110 can provide information regarding the current load placed on each of the index server resources within the index server system 102. The load may refer to the number of queries per second each index server resource is handling. In addition, or alternatively, the traffic determination module 110 can provide information regarding the current latency exhibited by the index server resources. The latency may refer to how long an index server resource takes to answer a query.

In one implementation, the traffic determination module 110 can receive and organize the traffic information into a uniform format for processing by the provisioning system 104. In addition, in some implementations, the traffic determination module 110 can perform prediction based on the traffic information which it receives from the index server system 102. This allows the traffic determination module 110 to learn trends that can be inferred from the traffic that is actually experienced by the index server resources. In this case, the traffic determination module 110 can send traffic information to the allocation manager module 114 that pertains to actual experienced traffic, as well as information that can be inferred from the actual experienced traffic.

The provisioning system 104 also includes an index system management module 112. The index system management module 112 provides information that describes the management status of the index server resources within the index server system 102. For example, the management status information may convey the state of each index server resource, e.g., whether the resource is active, idle, or in some other state. For example, a certain percentage of the index server resources may be inactive due to routine maintenance, malfunction, or some other factor(s).

The provisioning system 104 may collect information from any other source or sources. Generally, the provisioning system 104 collects information that has any bearing on the allocation of index server resources to the different vying partner entities 106. The information that is collected is generally referred to as “collected information” herein.

An allocation manager module 114 performs the core function of the provisioning system 104 by allocating index server resources to the different partner entities 106 based on the collected information. The allocation manager module 114 can use any environment-specific functionality and allocation paradigm(s) to perform this task. In one case, the allocation manager module 114 can apply one or more fairness considerations to distribute the index server resources among the different vying uses. In addition, the allocation manager module 114 can assign different levels of importance to different respective uses. The allocation manager module 114 can use this importance information to give priority to certain uses over others. For example, the allocation manager module 114 can designate normal production traffic as having a highest level of importance. In this case, when the demand for search-related services among ordinary users exceeds allocated capacity, the allocation manager module 114 can reallocate index server resources from “supplemental” uses (such as experimental and testing uses) to the normal production traffic. In addition, or alternatively, in certain commercial implementations, a partner entity can establish priority over other uses by paying a fee.

In one case, the allocation manager module 114 can formulate allocation instructions which instruct the index server system 102 to allocate subsets of index server resources to specified partner entities. For example, the allocation manager module 114 can instruct the index server system 102 to allocate the first x rows to normal production use, the next y rows to a particular foreign market, the next z rows to relevancy experiments, and so on.

There may be circumstances in which, after allocation, the index server system 102 still yields a total capacity which exceeds demand. In this scenario, the allocation manager module 114 can provide instructions which instruct the index server system 102 to power-down subsets of index server resources. For example, the allocation manager module 114 can instruct the index server system 102 to shut down r percent of its index server resources, or to place these index server resources in some type of low-power state (e.g., a hibernate state). This use of the index server resources can be considered a “null” use.

In one case, the allocation manager module 114 applies allocation functionality that is configurable to suit different environments. For example, an administrator can set up the allocation manager module 114 in a particular environment to exercise some allocation functions but not others.

A monitoring module 116 allows any authorized user to examine the allocations that have been made by the allocation manager module 114 over any time span. For example, an administrator may wish to examine the allocation instructions to gain insight regarding the level of service that is being offered to different partner entities. This allows the administrator to improve the performance of the allocation manager module 114. For example, the administrator may conclude that the allocation manager module 114 is unduly favoring a particular experimental use of the index server resources to the detriment of normal production traffic. The administrator can adjust weights associated with different uses to improve the performance of the allocation manager module 114. Any partner entity can also use the monitoring module 116 for any reason.

A query routing module 118 of the index server system 102 can receive and implement the instructions of the allocation manager module 114. For example, suppose the allocation instructions specify that rows 1-10 are to be allocated to normal production use and that rows 11-15 are to be devoted to relevancy experiments. The query routing module 118 can thereafter route a query associated with normal production traffic to one of the rows 1-10, while routing a query associated with experimental use to one of the rows 11-15. The query routing module 118 can distinguish the type of query it receives in any manner. For example, the query routing module 118 can detect address information which indicates the origin of the query. Alternatively, or in addition, the query itself can include one or more fields which indicate its origin (and nature). For example, an analyst who sends a batch of experimental queries can tag these queries with supplemental information which identifies them as experimental queries. The query routing module 118 can use load balancing functionality to route such a query to one of the rows that has been designated for serving that type of query.

Advancing again to FIG. 2, this figure shows the effects of one particular allocation of index server resources. Here, the provisioning system 104 has allocated at least rows 202 and 204 to serve normal product traffic (demarcated by “P”). The provisioning system 104 has allocated at least rows 206 and 208 to serve experimental traffic. This is merely a simplified example. In other cases, the provisioning system 104 can partition the available index server resources into any number of partitions.

Further, the provisioning system 104 manages the partitions in a dynamic manner. This means that the provisioning system 104 can readily change the partitions based on changes conveyed by the collected information (e.g., the request information, the traffic information, and the management status information). For example, assume that the provisioning system 104 experiences a large demand in normal production traffic at particular time of the day. The provisioning system 104 can respond by reallocating rows 206 and 208 to normal production traffic, as opposed to experimental traffic. In another case, assume that that status management information indicates that row 202 is undergoing maintenance and is therefore temporally unavailable for normal production use. The provisioning system can again respond by reallocating either row 206 or row 208 to normal production use. In this case, it is assumed that the normal production traffic is ranked higher in importance than experimental use. But in general, environment-specific factors govern the weighting applied to each use.

The allocation manager module 114 can modify the above-described dynamic allocation by applying smoothing functionality. The smoothing functionality is operative to ignore short-lived changes in traffic or other events. This will prevent the provisioning system 104 from attempting to make unstable allocations. In other words, there is a cost associated with the act of reallocation itself, which the allocation manager module 114 takes into account by disabling reallocation for transient changes in the operating environment. In addition, although not shown in FIG. 2, the provisioning system 105 can power down any number of rows of index server resources that are not needed by any partner entity.

FIG. 3 is a plot which expresses the demand placed on the index server system 102 over the course of time. For example, the plot can express the demand in terms of Queries-Per-Second, indicating the number of queries that have been processed by the index server system 102 within a second. More specifically, the solid undulating line represents the demand for index server resources that originates from normal production use alone, without deployment of the provisioning system 104. As can be seen, the demand varies with time. For example, the demand may be highest at midday and lowest late at night.

In contrast, the dashed line represents the overall demand for index server resources that originates from all vying uses, here with deployment of the provisioning system 104. As can be seen, the provisioning system 104 acts to smooth the overall demand. It may perform this task by “transferring” excess capacity that is not needed by normal production use during certain times of the day to other supplemental uses. In another example, the provisioning system 104 can transfer index serving resources between two productions uses in different regions of the world. For example, a US search center can “donate” index server resources to a search center in India during nighttime periods in the US, and vice versa. This is because demand in the US can be expected to be low during periods of high demand in India, and vice versa.

As a consequence, the provisioning system 104 enables the index server system 102 to make more efficient use of its index server resources. This, in turn, allows the index server system 102 to, overall, deploy fewer index server resources to meet various demands. This also allows the index server system 102 to more effectively meet the type of demand that increases as a function of time as more users gain access to the Internet and wish to use search-related services. These characteristics may enable the provisioning system 104 to offer better user experience, as well as reduce financial costs associated with running a search-related service. The financial expenditure includes the cost of running and maintaining the index server resources, as well as the cost of adding new index server resources to the index server system 102.

FIG. 1 shows a first scenario in which a single allocation manager module 114 controls the allocation of resources of a single index server system 102. That single allocation manager module 114 receives information from a single partner processing module 108. This architecture can be varied in many ways, three of which are shown in FIGS. 4-6.

In FIG. 4, at least two allocation manager modules (402, 404) control the allocation of index server resources in at least two respective index server systems (406, 408). A single partner processing module 410 may forward collected information to the allocation manager modules (402, 404).

In this scenario, each local allocation manager module can act in an independent fashion. Any local allocation manager module can gain insight into the operation of other allocation manager modules in indirect fashion, e.g., by noting changes in demand that originate from allocations made by other allocation manager modules. In addition, or alternatively, the allocation manager modules (402, 404) can conduct peer-to-peer communication in any manner to alert each other to the allocations which they have made to their respective local server systems.

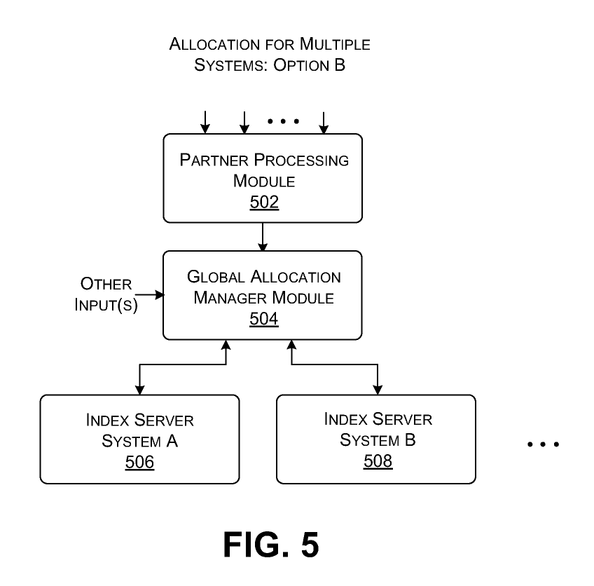

In FIG. 5, a single partner processing module 502 forwards collected information to a single allocation manager module 504. The single allocation manger module 504, in turn, controls two or more index server systems (506, 508). In this scenario, the allocation manager module 504 acts as a global manager which takes into account all of the index server resources offered by the two or more index server systems (506, 508).

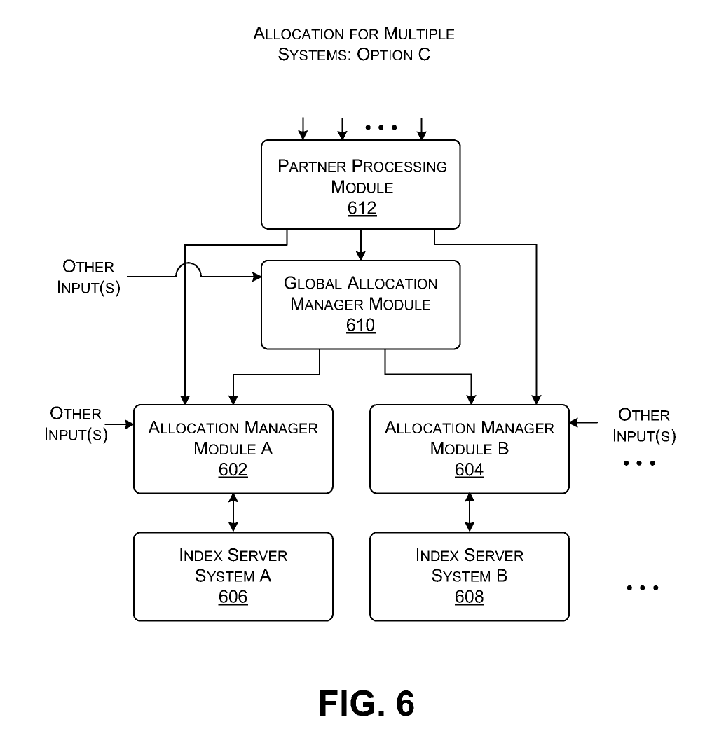

FIG. 6 is a hybrid architecture that combines some principles of the architectures of FIGS. 4 and 5. Namely, in this case, at least two local allocation manger modules (602, 604) provide local control of the allocation within at least two respective local index server systems (606, 608). In addition, a global allocation manager module 610 effectively manages the allocations performed by the local allocation manager modules (602, 604). A single partner processing module 612 can provide collected information to all of the allocation manager modules (602, 604, 610), or just to the global allocation manager module 610.

In one scenario associated with the architecture of FIG. 6, the local allocation manager modules (602, 604) can make local allocation decisions which mainly reflect local considerations that have a bearing on their respective local index server system (606, 608). But the local allocation manager modules (602, 604) can also receive guidance from the global allocation manager module 610 which influences their local decisions. The global allocation manager module 610 can make general allocation decisions which take into account the performance of the search engine system as a whole.

To repeat, the examples presented in FIGS. 4-6 are to be interpreted as representative, rather than exhaustive of the possible provisioning system architectures. Further, the architectures in FIGS. 4-6 depict a single partner processing module (410, 502, 612). In other implementations, the architectures can include additional partner processing modules, such as local partner processing modules. Further, although not enumerated in detail, the allocation management modules (402, 404, 504, 602, 604, 610) can receive other types of information (such as traffic information and management status information), originating from any respective local and/or global sources of such information.

The functionality described in this section can be implemented by any combination of processing equipment. For example, the search engine system 100 of FIG. 1 can be implemented by one or more data centers, each provided at a single site or distributed over plural sites. The index server system 102 itself can include a collection of server computers, a collection of data stores, routing functionality, and so on. Likewise, the provisioning system 104 can be implemented using one or more server computers, one or more data stores, and so on. The provisioning system 104 can be located at the same site as the index server system 102, or at a different site, or partially at the index server system site and partially elsewhere.

Any type of coupling mechanism can connect the various components described herein together. For example, a user may access the search engine system 100 using any type of user device via any type of network, such as a wide area network (e.g., the Internet), a local area network, and so on. The network can be implemented by any combination of wired links, wireless links, name servers, routers, gateways, etc., governed by any protocol or combination of protocols. Likewise, the partner entities 106 can interact with the provisioning system 104 using any type of network connection or other coupling mechanism. Likewise, the provisioning system 104 can interact with the index server system 102 via any of network connection or other coupling mechanism.

B. Illustrative Processes

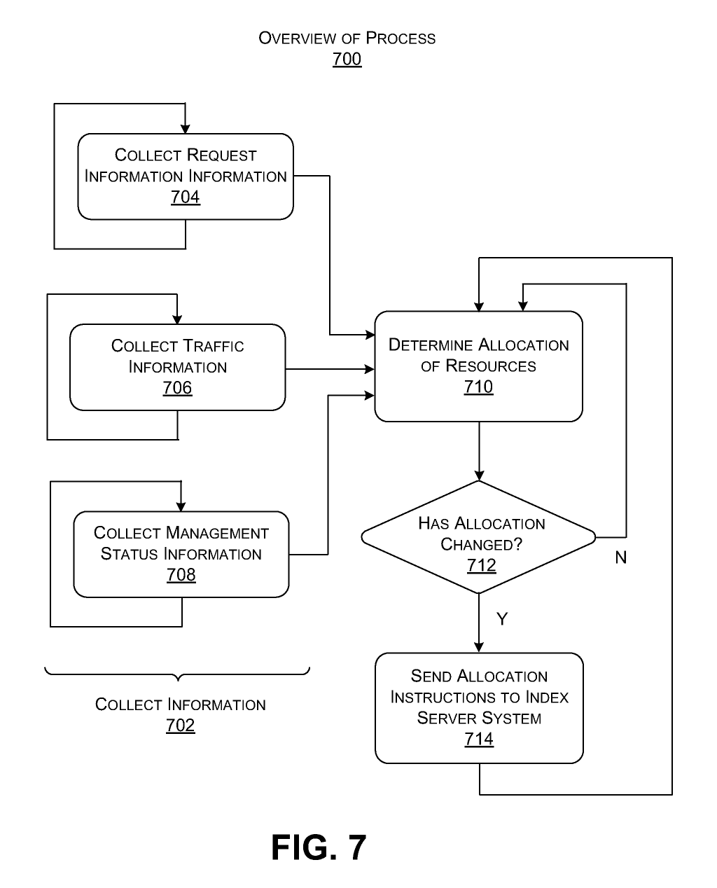

FIG. 7 shows a procedure 700 which represents one manner of operation of the provisioning system 104 of FIG. 1. Since the principles underlying the operation of the provisioning system 104 have already been described in Section A, certain operations will be addressed in summary fashion in this section.

In block 702, the provisioning system 104 generally collects information which has a bearing on the allocation determinations made within the search engine system 100. For example, in block 704, the provisioning system 104 collects resource information which describes the quantity and type of index server resources that are being requested by one or more partner entities (referred to as requested index server resources). In block 706, the provisioning system 104 collects traffic information which describes the nature of traffic currently being experienced by the index server system 102. For instance, the traffic information may describe the load being placed on the index server resources, as well as the latency exhibited by the index server resources. In block 708, the provisioning system 104 can collect management status information which describes the management status of the index server resources. For example, the management status information may indicate whether each particular index sever resource is active, inactive, or in some other state.

The collecting operations illustrated in blocks 704, 706, and 708 can be conducted on any basis. For example, in one case, the provisioning system 104 can perform each of blocks 704, 706, and 708 in a periodic manner, independent from the other collection operations. Alternatively, or in addition, the provisioning system 104 can perform at least some of blocks 704, 706, and 708 in an event-driven manner. For example, the allocation manager module 114 can receive new request information only when a partner entity submits such new information. Further, the allocation manager module 114 can receive new traffic information only when that traffic information markedly departs from prior collected traffic information. In general, the provisioning system 104 can receive the collected information using a push-based paradigm (in which the sources of information independently forward the information to the provisioning system 104), a pull-based paradigm (in which the provisioning system actively polls the sources of information), or a combination thereof.

In block 710, the allocation manager module 114 processes the collected information to determine whether it warrants a change to the current allocation of index server resources. As described above, the allocation manager module 114 can apply any environment-specific consideration(s) in making this decision. Such considerations include fairness-based factors, priority-based factors, and so on. If the collected information warrants a new allocation (as assessed in block 712), then, in block 714, the allocation manager module 114 sends instructions to the index server system 102 that command it to change its allocation of resources. If the collected information warrants no change, then the allocation manager module 114 sends no instructions to the index server system 102.

C. Representative Processing Functionality

FIG. 8 sets forth illustrative electrical data processing functionality 800 that can be used to implement any aspect of the functions described above. With reference to FIGS. 1 and 2, for instance, the type of processing functionality 800 shown in FIG. 8 can be used to implement any aspect of the search engine system 100, including any aspect of the provisioning system 104 and/or any aspect of the index server system 102. In addition, the processing functionality 800 may describe the general architecture of a user device and any partner entity device which interact with the search engine system 100. In one case, the processing functionality 800 may correspond to any type of general-purpose or special-purpose computing device (or plural such computing devices), each of which includes one or more processing devices.

The processing functionality 800 can include volatile and non-volatile memory, such as RAM 802 and ROM 804, as well as one or more processing devices 806. The processing functionality 800 also optionally includes various media devices 808, such as a hard disk module, an optical disk module, and so forth. The processing functionality 800 can perform various operations identified above when the processing device(s) 806 executes instructions that are maintained by memory (e.g., RAM 802, ROM 804, or elsewhere). More generally, instructions and other information can be stored on any computer readable medium 810, including, but not limited to, static memory storage devices, magnetic storage devices, optical storage devices, and so on. The term computer readable medium also encompasses plural storage devices.

The processing functionality 800 optionally also includes an input/output module 812 for receiving various inputs from a user (via input modules 814), and for providing various outputs to the user (via output modules). One particular output mechanism may include a presentation module 816 and an associated graphical user interface (GUI) 818. The processing functionality 800 can also include one or more network interfaces 820 for exchanging data with other devices via one or more communication conduits 822. One or more communication buses 824 communicatively couple the above-described components together.

Various features of the processing functionality 800 can be omitted or modified, depending on the application of the processing functionality 800. For example, when implemented using general-purpose server computer devices, the processing functionality 800 generally includes any type of processing resources, memory resources, data storage resources, and communication resources.

In closing, the description may have described various concepts in the context of illustrative challenges or problems. This manner of explication does not constitute an admission that others have appreciated and/or articulated the challenges or problems in the manner specified herein.

More generally, although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for allocating index server resources used by a search engine system, comprising:
collecting information that has a bearing on resource allocation determinations within the search engine system, to provide collected information, the collected information including resource request information that describes index server resources that are being requested by at least one partner entity;
determining an allocation of index server resources based on the collected information, to provide a determined allocation; and
sending allocation instructions to an index server system to carry out the determined allocation.

2. The method of claim 1, wherein the resource request information identifies an amount of the index server resources that is being requested by said at least one partner entity.

3. The method of claim 1, wherein the resource request information identifies a type of index information that is being requested by said at least one partner entity.

4. The method of claim 1, wherein the resource request information identifies a type of processing functionality that is being requested by said at least one partner entity.

5. The method of claim 1, wherein said at least one partner entity includes a partner entity that uses index server resources for evaluating processing functionality used by the search engine system.

6. The method of claim 1, wherein said at least one partner entity includes a partner entity that uses index server resources in a defined geographic area in which a searcher-related service is provided.

7. The method of claim 1, wherein said at least one partner entity includes a partner entity that uses index server resources for testing of processing functionality prior to deployment of the processing functionality by the search engine system.

8. The method of claim 1, wherein the collected information also includes traffic information that describes behavior of currently-allocated index server resources.

9. The method of claim 8, wherein the traffic information identifies load placed on the currently-allocated index server resources.

10. The method of claim 8, wherein the traffic information identifies latency exhibited by the currently-allocated index server resources.

11. The method of claim 1, wherein the collected information also includes management status information that describes current status of the index server resources used by the search engine system.

12. The method of claim 1, wherein the index server resources used by the search engine system comprise plural subsets of index server resources, each subset collectively providing index information for a corpus of documents, and wherein the allocation instructions result in allocation of at least one subset of index server resources to said at least one partner entity.

13. The method of claim 12, wherein the plural subsets comprise plural rows of index servers.

14. A provisioning system for provisioning index server resources used by a search engine system, comprising:
a partner processing module configured to collect resource request information that describes index server resources that are being requested by at least one partner entity;
a traffic determination module configured to collect traffic information that describes behavior of currently-allocated index server resources; and
an allocation manager module configured to dynamically determine an allocation of index server resources based on the resource request information and traffic information, to provided a determined allocation,
the allocation manager module further configured to send allocation instructions to an index server system to carry out the determined allocation.

15. The provisioning system of claim 14, further comprising an index system management module configured to provide management status information that describes current status of the index server resources used by the search engine system.

16. The provisioning system of claim 14, further comprising a monitoring module configured to provide information to a user regarding allocation determinations made by the allocation management module.

17. The provisioning system of claim 14, wherein the index server resources used by the search engine system comprise plural rows of index server resources that collectively provide index information for a corpus of documents, and wherein the allocation instructions result in allocation of at least one row of index server resources to said at least one partner entity.

18. The provision system of claim 14, wherein the allocation manager module is a global allocation manager module that manages allocation of index server resources used by at least two index server systems.

19. A computer readable medium for storing computer readable instructions, the computer readable instructions providing a provisioning system for provisioning index server resources used by a search engine system, the computer readable instructions comprising:
a partner processing module configured to collect resource request information that describes index server resources that are being requested by at least one partner entity;
a traffic determination module configured to collect traffic information that describes behavior of currently-allocated index server resources;
an index system management module configured to provide management status information that describes current status of the index server resources used by the search engine system; and
an allocation manager module configured to dynamically and automatically determine an allocation of index server resources based on the resource request information, traffic information, and management status information, to provide a determined allocation,
the allocation manager module further configured to send allocation instructions to an index server system to carry out the determined allocation,
the index server resources used by the search engine system comprising plural subsets of index server resources that collectively provide index information for a corpus of documents, and wherein the allocation instructions result in allocation of at least one subset of index server resources to said at least one partner entity.

20. The computer readable medium of claim 19, further comprising a monitoring module configured to provide information to a user regarding allocation determinations made by the allocation management module.
